(19) United States
(12) Patent Application Publication
(10) Pub. No.: US 2023/0237514 A1
(43) Pub. Date: Jul. 27, 2023

(54) SOFTWARE AS A SERVICE FOR MERGING AND MANAGING USER STRUCTURES

(71) Applicant: KWIKCLICK, LLC, Murray, UT (US)

(72) Inventor: Fred Cooper, Farmington, UT (US)

(21) Appl. No.: 18/090,172

(22) Filed: Dec. 28, 2022

Related U.S. Application Data
(63) Continuation-in-part of application No. 17/867,336, filed on Jul. 18, 2022, now abandoned.
(60) Provisional application No. 63/222,780, filed on Jul. 16, 2021.

(51) Int. Cl. G06Q 30/0201; G06F 16/22; G06F 7/14

(52) U.S. Cl. CPC G06Q 30/0201; G06F 16/2291; G06F 7/14

(57) ABSTRACT

Disclosed herein is a system and method to any two or more MLMs to be merged into a multiline MLM system despite having different commission structures. Each member of the original MLMs is able to maintain their existing downlines without any changes. Further the existing MLM members have full access to the multi-line MLM commission structure, for example, a member of a binary MLM may now add a 3rd, 4th, 5th, etc. line if they choose. The multiline commission plan will be different than the commission plans from any of the original MLMs but this change should not affect the income of a large portion of users, and users that are affected by the changeover can be compensated or made whole on an individual level. In addition to this multiline commission plan, the commission structure of the original MLMs has been broken into several separate ‘types’ which together form an MLM system. These ‘types’ include the income received from downline commission based on position and the income received based on enrolling a member in the MLM, also known as sponsorship. This system is one that may be hosted on the internet or cloud computing services and may provide remote access to the newly formed MLMs. The system will provide essential services to the MLMs such as databasing, commission calculation, and commission structure modification, for free or for a fee. MLMs, their agents, executives, employees, members, and other entities selected by the MLM will be able to access the system using secure credentials.

### CROSS-REFERENCE TO RELATED APPLICATION

The present application is a continuation-in-part and claims priority benefit of U.S. patent application Ser. No. 17/867,336 filed Jul. 18, 2022, which claims the priority benefit of U.S. provisional application number 63/222,780 filed Jul. 16, 2021, the disclosures of which are incorporated herein by reference.

### BACKGROUND OF THE INVENTION

### 1. Field of the Disclosure

The present disclosure is generally related to merging multi-level marketing systems.

### 2. Description of the Related Art

Multi-Level Marketing (MLM) companies are defined by a commission structure that is multi-level, such that a commission is paid to at least one member above the member who made a sale or purchase. However, there are multiple kinds of commission structures, for example, binary, matrix, or unilevel. Merging these companies while maintaining the integrity of the existing commission structure has been unsuccessful when the two companies do not have the same kind of commission structure. Usually, when companies with a different commission structure do merge, the two commission structures are simply kept separate and retain their traits and commission rates. Therefore, members of a traditional unilevel, binary, or matrix commission structure must continue to build that structure even if other members of the merged company are in a multi-level structure. If the merged company does decide to attempt to merge the commission structures, it often ends with members feeling disoriented or upset by changes that can impact income from commissions. There is a need for existing MLM companies to merge without having to either continue to keep the two or more companies separate or upset members by rearranging the existing commission structures.

Currently, merging a Unilevel, matrix, and/or binary MLM into a multiline without the assistance of a licensed third party risks infringing upon IP that protects that process. Therefore, for non-licensed MLMs the process must be facilitated. Merging large MLMs and/or multiple MLMs can also lead to logistics and data storage issues that the new merged MLM may not be equipped to handle. Merging non MLM companies is a time and resource intensive project which is often best left to experts and tailored software. Further still, running a merged MLM also presents difficulties and even those with extensive experience with MLMs will be at a disadvantage because of the organization of the multiline structure. Thus, there is a need for MLM companies to outsource the storage of data and handling of transactions to a third party, and multiline MLMs to overcome logistical issues associated with third party software service providers.

### BRIEF DESCRIPTION OF THE DRAWINGS

FIG. 1 illustrates a Multi-Level Marketing Merger System

FIG. 2 illustrates a Unilevel MLM User Structure

FIG. 3 illustrates a Binary MLM User Structure

FIG. 4 illustrates a Matrix MLM User Structure

FIG. 5 illustrates a Multiline MLM User Structure

FIG. 6 illustrates a Multiline MLM Commission Module

FIG. 7 illustrates a Multiline MLM Additional Line Module

FIG. 8 illustrates a Multiline MLM Merger Module

FIG. 9 Illustrates a Merged MLM Merged Base Module

FIG. 10 Illustrates an Admin Network AN Base Module

FIG. 11 Illustrates an Admin Network AN Commission Module

FIG. 12 Illustrates an Admin Network AN Additional Line Module

FIG. 13 Illustrates an Admin Network AN Portal Module

FIG. 14 Illustrates an Admin Network AN Payment Module

### DETAILED DESCRIPTION

Systems and methods for a Multi-Level Marketing Merger System are disclosed. The system includes Multiline MLM organization, which is a distribution organization characterized by a multi-level payment structure. In a Multiline MLM organization, a user is a distributor or a sales agent and may earn commission based on their own sales and the sales of other users. The user may have one or more users above the user in the organization structure, who are referred to as upline user. When the user makes a sale, the user may pay commission to one or more upline users. The user may have one or more users below the user in the organization structure, which is referred to as downline user. The user may receive commission from the downline users who have made a sale. The Multiline MLM organization may allow the user to have an infinite number of lines below the user, each line representing another user. Alternatively, the distribution organization may limit the number of downline users a user can have at a fixed number and only increase the number of downlines if the user has met a certain threshold criteria. In the case where the user has recruited a new user but has not met the criteria to open a new downline, the user may only retain the status as a sponsor or a recruiter but not be an upline user to the new user. Users who are in a relationship of receiving or paying commission to one another but not in each other's downline or upline are in a crossline relationship. For example, the sponsor who recruited the user may or may not be an upline user to the user in the Multiline MLM organization but still receive commission from the user via the crossline relationship. The commission rate paid to an upline user may be different from a crossline user or an upline user who is also the sponsor.

In contrast, a Unilevel, Binary, or Matrix MLM limit connections between users and sponsors based on structural differences. A Unilevel MLM lacks crossline relationship because the sponsor that recruited the user is an upline user of the user. The Unilevel MLM organization may have an infinite number of lines below the user as new recruits are recruited by the user. A Matrix MLM lacks crossline relationship because the sponsor that recruited the user is an upline user of the user. The Matrix MLM organization has a fixed width and depth of lines below the user as new recruits are recruited by the user. In the Matrix and Unilevel MLM a downline user pays commission to the upline user when a sale is made by the downline user. A Binary MLM restricts a sponsor to connect with only two downline users. If a sponsor that is already connected to two downline users recruits new users, the new users are placed in a different user downline. A crossline relationship may be created between the sponsor and the newly recruited user and the sponsor may receive commission related to the crossline relationship. However, the sponsor may not receive upline commission from the newly recruited users or the downline of the newly recruited users.

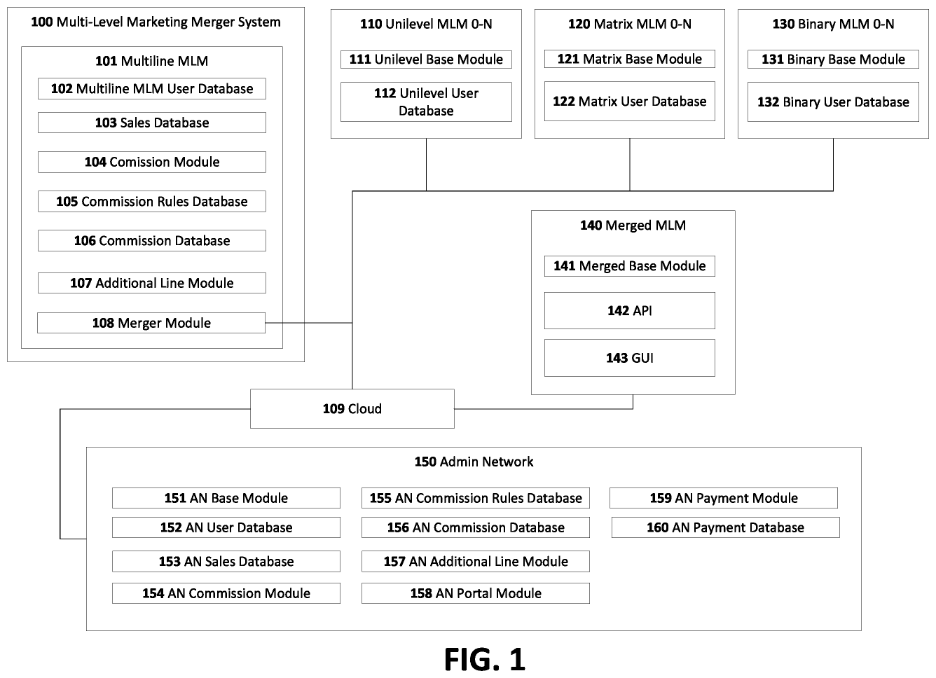

Merging the users of a Unilevel, Binary, or Matrix MLM into a Multiline MLM may require position and user connection changes for users of the different structures. Users of the Multiline MLM may have a maximum number of users possible as downline users until a commission threshold is reached, while Unilevel, Binary, and Matrix MLM users do not add possible downline users based on a commission threshold. The Multi-Level Marketing Merger System may instantaneously reorganize connections and positions of the users from the Unilevel, Binary, or Matrix MLM into the Multiline MLM to reconcile different commission rules from two or more organizations with different structures to find the optimal commission structures for users and maximize commission rates. This allows for a seamless transition without an interruption in the businesses. The Multi-Level Marketing Merger System may reorganize the different structures by creating crossline connections to sponsors and placing users in the downline of different users while maintaining the possible commission earned for each user. Based on commission rules in the Unilevel, Binary, or Matrix MLM and commission rules in the Multiline MLM the Multi-Level Marketing Merger System may update rules in the Multiline MLM associated with a user and the position of the user to ensure the possible commission earned by the user is comparable after the merger. The process for comparing and merging the systems is described in detail in FIGS. 1-14.

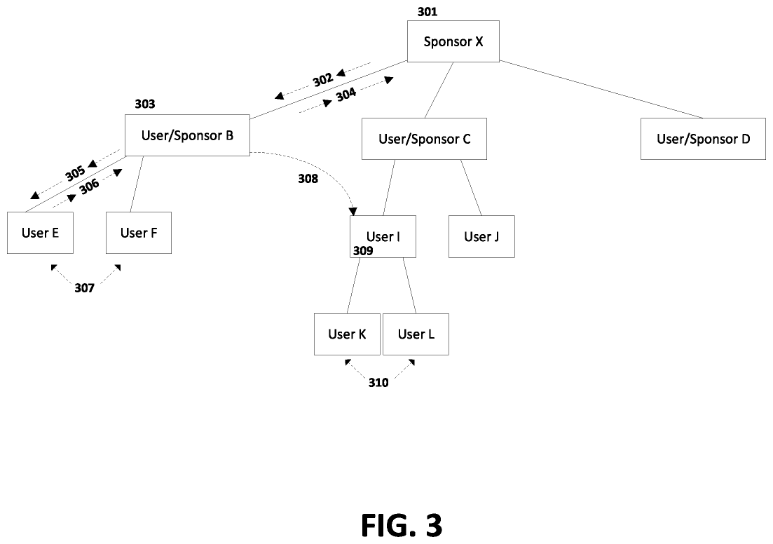

FIG. 1 illustrates a Multi-Level Marketing Merger System 100. The system includes a Multiline MLM organization 101, which in turn includes a Multiline MLM User Database 102, a Sales Database 103, a Commission Module 104, a Commission Rules Database 105, a Commission Database 106, an Additional Line Module 107, and a Merger Module 108. Structure of the Multiline MLM organization 101 is discussed in further detail in FIG. 3. The Multiline MLM User Database 102 may contain information about a user in the Multiline MLM organization structure, including data such as a user ID of the user, the ID of an upline user directly above the user, the ID of a sponsor user that enrolled the user in the Multiline MLM, the type of relationship between the user and other users, the position of the user in the organization hierarchy, and how many downlines the user is currently allowed. The type of relationship indicates whether the user is a sponsor, upline user, or downline user to other users. The Multiline MLM Sales Database 103 may contain data on sales made by the user, such as a user ID, a sale value, and a transaction date.

A Multiline MLM Commission Module 104 may receive data from the Multiline MLM Sales Database 103 to pay commissions to one or more other users. The Multiline MLM Commission Rules Database 105 may contain rules to calculate commission based on the position of the user in the Multiline MLM User Database 102 and sales data in the Multiline MLM Sales Database 103. The 104 Multiline MLM Commission Module may calculate commission based on sales data in the Multiline MLM Sales Database 103, the position of the user in the Multiline MLM User Database 102, and rules stored in the Multiline MLM Commission Rules Database 105 corresponding to the sales data and the position of the user. The calculated commission may be stored in the Multiline MLM Commission Database 106. In some embodiments, the Multiline MLM Commission Module 104 may pay users directly. The Multiline MLM Additional Line Module 107 may receive data from the Multiline MLM Commission Database 106 to determine if the user qualifies for an additional line.

The Multiline MLM Additional Line Module 107 may determine if the user has met a threshold commission value on their existing lines based on data from the Multiline MLM Commissions Database 106 and may add an additional line to the number of lines that the user is allowed. The Multiline MLM Additional Line Module 107 may update the Multiline MLM User Database 102, the Multiline MLM Commission Module 104, or any combination of databases with additional line data the user is allowed. In some embodiments, the Multiline MLM Commission Module 104 may calculate and store an additional commission for the user based on the additional line data. The Multiline MLM Merger Module 108 may receive data via a Cloud 109 from any number of MLM structures, such as a Unilevel MLM 110, a Matrix MLM 120, and a Binary MLM 130. The Cloud 109 may also send or receive data to the Merged MLM 140 and Admin Network 150. The Cloud 109 or communication network may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over Internet and relies on sharing of resources to achieve coherence and economies of scale.

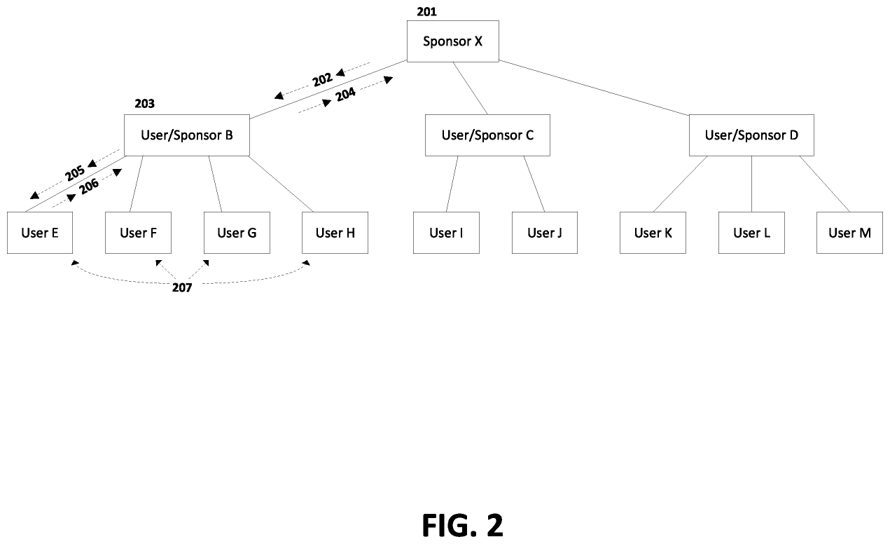

The Unilevel MLM organization 110 may include a distribution organization characterized by a Unilevel payment structure wherein a user of the organization is a distributor and pays commission to a sponsor user above the user in the distribution organization. The user in the Unilevel MLM organization 110 may also be a sponsor user by recruiting and adding a new user in a single line below the user. The sponsor user may receive commission from an infinite number of new users in the single line below the sponsor user. Structure of the Unilevel MLM organization 110 is discussed in further detail in FIG. 2. A Unilevel MLM Base Module 111 may extract data stored in a Unilevel MLM User Database 112 including information about the position of the user in the Unilevel MLM distribution organization structure, such as the sponsor user that enrolled the user in the Unilevel MLM, position of other users directly below the user in the user downline, position of other users directly above the user in the user upline, and commission rules of the Unilevel MLM distribution organization for the user. The Unilevel MLM Base Module 111 may send extracted data via the Cloud 109 to the Multiline MLM Merger Module 108 to be stored in the Multiline MLM User Database 102, the Multiline MLM Commission Rules Database 105, or any combination of databases in the 101 Multiline MLM system, the 140 Merged MLM, or the 150 Admin Network.

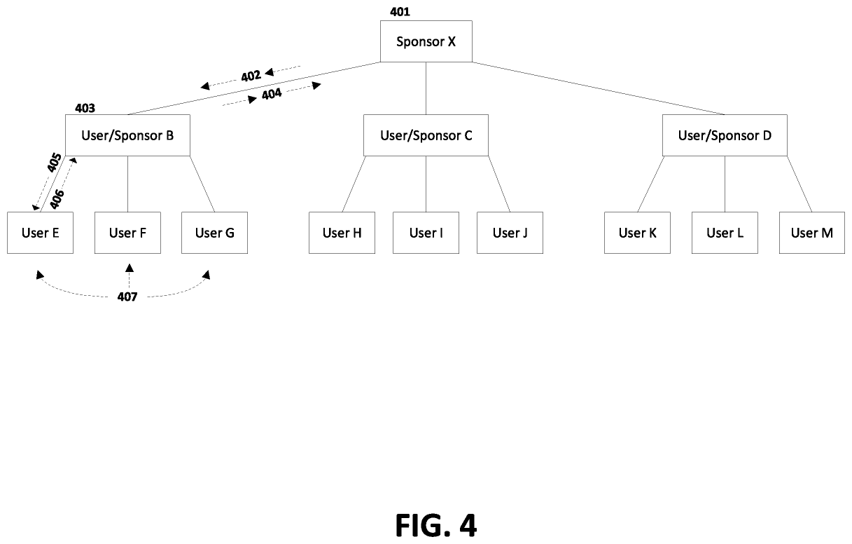

The Matrix MLM organization 120 may include a distribution organization characterized by a Matrix payment structure wherein a user of the organization is a distributor and pays commission to a sponsor user above the user in the distribution organization. The user in the Matrix MLM organization 120 may also be a sponsor user by recruiting and adding a new user in a matrix below the user. The sponsor user may receive commission from an fixed number of new users in the matrix below the sponsor user. Structure of the Matrix MLM organization 120 is discussed in further detail in FIG. 4. A Matrix MLM Base Module 121 may extract data stored in a Matrix MLM User Database 122 including information about the position of the user in the Matrix MLM distribution organization structure, such as the sponsor user that enrolled the user in the Matrix MLM, position of other users directly below the user in the user downline, position of other users directly above the user in the user upline, and commission rules of the Matrix MLM distribution organization for the user. The Matrix MLM Base Module 121 may send extracted data via the Cloud 109 to the Multiline MLM Merger Module 108 to be stored in the Multiline MLM User Database 102, the Multiline MLM Commission Rules Database 105, or any combination of databases in the 101 Multiline MLM system, the 140 Merged MLM, or the 150 Admin Network.

The Binary MLM organization 130 may include a distribution organization characterized by a Binary payment structure wherein a user of the organization is a distributor and pays commission to a sponsor user above the user in the distribution organization. The user in the Binary MLM organization 130 may also be a sponsor user by recruiting and adding a new user in a single line below the user. The sponsor user may receive commission from two users in a downline below the sponsor user, and an infinite number of users with a crossline sponsor connection. Structure of the Binary MLM organization 130 is discussed in further detail in FIG. 3. A Binary MLM Base Module 131 may extract data stored in a Binary MLM User Database 132 including information about the position of the user in the Binary MLM distribution organization structure, such as the sponsor user that enrolled the user in the Binary MLM, position of other users directly below the user in the user downline, position of other users directly above the user in the user upline, and commission rules of the Binary MLM distribution organization for the user. The Binary MLM Base Module 131 may send extracted data via the Cloud 109 to the Multiline MLM Merger Module 108 to be stored in the Multiline MLM User Database 102, the Multiline MLM Commission Rules Database 105, or any combination of databases in the 101 Multiline MLM system, the 140 Merged MLM, or the 150 Admin Network.

A 141 Merged MLM Merged Base Module may connect with the 150 Admin Network AN Portal Module, and sends the 140 Merged MLM's credentials for logging into the 150 Admin Network. If the credentials are valid then the 158 Admin Network Portal Module allows access to the 150 Admin Network. A 142 Merged MLM API allows the 140 Merged MLM to manipulate and retrieve data stored on the 150 Admin Network once credentials have been verified by the 158 Admin Network AN Portal Module. An API may be a set of functions and procedures allowing the creation of applications that access the features or data of an operating system, application, or other service. A 143 Merged MLM GUI allows members, employees, executives or anyone otherwise involved with the 140 Merged MLM to interact with the 150 Admin Network through graphical icons and audio indicator such as primary notation, instead of text-based user interfaces, typed command labels or text navigation. A 150 Admin Network is a software service which may be hosted locally, remotely, or on the 109 Cloud or Internet and which provides for the 140 Merged MLM a system of modules and databases which are essential or beneficial to the running of an MLM. In some embodiments the 150 Admin Network may be applicable to any MLM structure, including but not limited to, Unilevel, matrix, binary, or Multiline. The 150 Admin Network may require an MLM to register credentials in order to access some or all of the features of the 150 Admin Network, and may also require recurring or one time payment for some or all of the services. In an embodiment one 150 Admin Network can provide services to multiple MLMs. In another embodiment each MLM has access to a specific iteration of the 150 Admin Network. A 151 Admin Network AN Base Module receives the initial user data for the newly formed 140 Merged MLM from the Multiline MLM Merger Module and stores that data in the 152 Admin Network AN User Database.

A 152 Admin Network AN User Database which contains the initial user data for the 140 Merged MLM and can be later added to or edited by the 140 Merged MLM after logging in to the 150 Admin Network. The 152 Admin Network AN User Database contains a user ID, for example, UL002, information on user's position in the 140 Merged MLM commission structure, for example the user ID of the user above them in the commission structure, for example, UL001, who enrolled or sponsored the user in the 140 Merged MLM or the original MLM that was merged into the 140 Merged MLM, for example, user ID UL001, and how many lines the user is currently allowed, for example, 7. Users are assigned a default number of lines when they join the 140 Merged MLM, users that were merged from another MLM. For example, the 110 Unilevel MLM will come into the 140 Merged MLM with at least the number of lines they had under their old MLM structure, in an embodiment the default number of lines is 4. The 152 Admin neetwork AN User Database contains initial data from the 108 Multiline MLM Merger Module, then is continuously updated by the 140 Merged MLM, members of the 140 Merged MLM, third parties, or any other entity which may enroll new members or edit the data of existing members in the 140 Merged MLM.

A 153 Admin Network AN Sales Database may contain data on sales made by users, which is used by the 154 Admin Network Commission Module to pay commissions to other users. The database may be added to or edited by the 140 Merged MLM after logging in to the 150 Admin Network. In an embodiment the database may receive data directly from members of the 140 Merged MLM when a sale is made, in an embodiment sales data may come directly from the vendor of the product sold. The 153 Admin Network AN Sales Database contains data on sales made by users, such as a user ID, for example, UL001, a sale value, for example, $134.90, and a transaction date, for example, Jan. 12, 2020, which is used by the 154 Admin Network AN Commission Module to pay commissions to other users. In some embodiments the database may include more sales data such as the seller's ID if applicable, item IDs of the items sold, volume sold, payment method and data, etc., and may contain sales data from before the merger if the data is available.

A 154 Admin Network AN Commission Module may calculate commission based on new sales data in the 153 Admin Network AN Sales Database and stores that commission in the 156 Admin Network AN Commission Database. In some embodiments the 154 Admin Network AN Commission Module may also pay users directly.

A 155 Admin Network AN Commission Rules Database which stores commission rules which are used by the 154 Admin Network AN Commission Module to determine commissions. The database may be added to or edited by the 140 Merged MLM after logging in to the 150 Admin Network. Commission rules can be complex or simple but will often involve a mathematical calculation, for example, a rule may dictate that commissions for upline users are 10% of the sales value, divided by two for each level above the selling user, meaning that for a $100 dollar sale the upline user will receive $10 the user above them, or 2nd level of influence from the user who made the sale, will receive $5, the user above them will receive $2.50, etc. In another example, the rule may dictate that the commission for sponsors is 15% of the sale but only if the sale is over $500, otherwise no commission is paid, the database also contains the type of rule, for example, “Sponsor” which indicates that the rule should be used to calculate commissions for sponsors. In some embodiments multiple rules may exist for one rule type, for example, one rule may apply to sponsors that are also somewhere upline of the user who made the sale, while a different sponsor rule may apply if the sponsor is cross-line, meaning they are not anywhere upline of the user who made the sale. In an embodiment, the commission rules may also include a “Leadership Bonus” which may amend the rule based on recruiting or volume sold by a user, for example, a user with 10 lines may receive 12% commission instead of 10% and a user with 20 lines may receive a 14% commission instead of 10% or 12%, element 2000.

A 156 Admin Network AN Commission Database which stores commissions calculated by the 154 Admin Network AN Commission Module which are then used by the 157 Admin Network AN Additional Line Module to determine if the user qualifies for an additional line. In some embodiments this data may be used by another module to pay commissions to users, which comprises at least a user ID, for example, UL001, a commission value, for example, $19.32, the type of commission, for example, downline, the user ID of the user the commission came from, for example, UL002, and a date, for example, Sep. 18, 2020. If the commission came from a sale made somewhere in a user's downline then the commission will be considered to come from the immediately downline user. In other embodiments the commission may be recorded as coming from the selling user.

A 157 Admin Network AN Additional Line Module determines if the user has met the threshold commission value on their existing lines based on data from the 156 Admin Network AN Commission Database and if so adds an additional line to the number of lines that user is allowed. A 158 Admin Network AN Portal Module receives a request for connection from the 141 Merged MLM Merged Base Module, prompts for credentials, receives credentials, checks the 160 Admin Network AN Payment Database to see if the credentials match and payment has been made, and if so allows the 140 Merged MLM access to some or all of the features of the 150 Admin Network. A 159 Admin Network AN Payment Module checks the 160 Admin Network AN Payment Database for outstanding payments and sends a request for payment to the 140 Merged MLM or its agents via the billing information stored in the database, prompts for payment information, processes payment, and stores a record of the processed payment in the 160 Admin Network AN Payment Database. In some embodiments this process may require a third party to receive payment information from the 140 Merged MLM and enter the information into the 159 Admin Network AN Payment Module.

A 160 Admin Network AN Payment Database contains data on payments that have been made, or are outstanding for use of the 150 Admin Network services, as well as contact or billing information so that additional requests for payment can be made by the 159 Admin Network AN Payment Module. This data includes an MLM ID, for example MLM01, password, for example, _˜;#FXFuuQ3H5=nH, a pay period, for example, March 2020, an amount to be paid for the pay period or service fee, for example, $5000, an amount already paid for the pay period or paid balance, for example, $5000, and contact or billing information where the MLM would like requests for payment sent. The data from the database is used by the 158 Admin Network AN Portal Module to determine if a person or entity trying to gain access to the 150 Admin Network has valid credentials and no outstanding balance before allowing access.

Functioning of the 102 Multiline MLM Multiline User Database will now be explained with reference to FIG. 2. The 102 Multiline MLM Multiline User Database contains a user ID, for example, AB0001, information on user's position in the 101 Multiline MLM commission structure, for example the user ID of the user above them in the commission structure, for example, FH1234, who enrolled or sponsored the user in the 101 Multiline MLM, for example, user ID TT9876, and how many lines the user is currently allowed, for example, 7, users are assigned a default number of lines when they join the 101 Multiline MLM, users that were merged from another MLM, for example, the 110 Unilevel MLM will come into the 101 Multiline MLM with at least the number of lines they had under their old MLM structure, in an embodiment the default number of lines is 4, FIG. 2B shows a possible commission structure based on the data in FIG. 2A, wherein the straight lines indicate an upline/downline relationship between two users and a curved, arrowed line indicates that the user the arrow points to was sponsored by the user the line originates from, more lines and users may exist than are shown, element 200.

The 103 Multiline MLM Sales Database contains data on sales made by users, which includes a user ID, for example, AB0001, a sale value, for example, $432.10, and a transaction date, for example, Jan. 7, 2020, which is used by the 104 Multiline MLM Commission Module to pay commissions to other users, in some embodiments the database may include more sales data such as the seller's ID if applicable, item IDs of the items sold, volume sold, payment method and data, etc.

104 Multiline MLM Commission Module may poll for a new data entry in the 103 Multiline MLM Sales Database, for example, when a sale is made by a user. The 104 Multiline MLM Commission Module extracts the new data entry from the 103 Multiline MLM Sales Database which includes at least a user ID, sales value, and date. The 104 Multiline MLM Commission Module searches for a User ID in the 102 Multiline MLM Multiline User Database that matches the user ID extracted from the 103 Multiline MLM Sales Database. For example if the extracted user ID had a value of “AB0001” then the 104 Multiline MLM Commission Module will search the 102 Multiline MLM Multiline User Database for a value of “AB0001” in the “User ID” category. The 104 Multiline MLM Commission Module selects the entry in the 102 Multiline MLM Multiline User Database with a matching user ID value. The 104 Multiline MLM Commission Module determines if the user has a sponsor by checking the entry for a value in the “Sponsor User ID” category. If there is no value, or the value does not correspond to a user ID then the 104 Multiline MLM Commission Module will skip to checking if the user has an upline user. If there is a value that corresponds to a user ID in the “Sponsor User ID” category, the 104 Multiline MLM Commission Module extracts the commission rule from the 105 Multiline MLM Commission Rule Database for sponsor users. The 104 Multiline MLM Commission Module applies the extracted commission rule to the sales value extracted from the 103 Multiline MLM Sales Database, for example if the rule is 10% commission for sponsors and the sales value is $300, then $300 will be multiplied by 10% to get $30 which is the commission payable to the sponsor, in an embodiment the sponsor may be paid directly by the 104 Multiline MLM Commission Module. The 104 Multiline MLM Commission Module stores the resulting commission in the 106 Multiline MLM Commission Database along with the user ID of the sponsoring user to be paid, the user ID of the sponsored user, the commission type, in this case sponsor, and the date extracted from the 103 Multiline MLM Sales Database, in some embodiments the date may be changed to reflect a delay in the processing of the commission or payment of the commission. The 104 Multiline MLM Commission Module determines if the user has an upline user by checking the entry for a value in the “Upline User ID” category, if there is no value, or the value does not correspond to a user ID then the 104 Multiline MLM Commission Module will return to polling for a new data entry in the 103 Multiline MLM Sales Database. If there is a value that corresponds to a user ID in the “Upline User ID” category, the 104 Multiline MLM Commission Module extracts the commission rule from the 105 Multiline MLM Commission Rule Database for upline user. The 104 Multiline MLM Commission Module applies the extracted commission rule to the sales value extracted from the 103 Multiline MLM Sales Database, for example if the rule is 10% commission for upline users and the sales value is $300, then $300 will be multiplied by 10% to get $30 which is the commission payable to the upline user, in some embodiments users may receive a different commission based on how many levels upline they are from the user who made the sale, for example, the upline user of the upline user may earn 5% commission, and next upline user may earn 1% commission, in an embodiment the upline user may be paid directly by the 104 Multiline MLM Commission Module. The 104 Multiline MLM Commission Module stores the resulting commission in the 106 Multiline MLM Commission Database along with the user ID of the upline user to be paid, the user ID of the downline user, the commission type, in this case upline, and the date extracted from the 103 Multiline MLM Sales Database, in some embodiments the date may be changed to reflect a delay in the processing of the commission or payment of the commission. The 104 Multiline MLM Commission Module then searches the 102 Multiline MLM Multiline User Database for an entry where the user ID in the “User ID” category matches the user ID in the “Upline User ID” category of the currently selected entry. The 104 Multiline MLM Commission Module selects the entry with the matching user ID value as the new selected entry.

The 105 Multiline MLM Commission Rules Database contains commission rules which are used by the 104 Multiline MLM Commission Module to determine commissions, commission rules can be complex or simple but will often involve a mathematical calculation. For example, a rule may dictate that commissions for upline users are 10% of the sales value, divided by two for each level above the selling user, meaning that for a $100 dollar sale the upline user will receive $10 the user above them, or 2nd level of influence from the user who made the sale, will receive $5, the user above them will receive $2.50, etc. In another example the rule may dictate that the commission for sponsors is 15% of the sale but only if the sale is over $500, otherwise no commission is paid, the database also contains the type of rule, for example, “Sponsor” which indicates that the rule should be used to calculate commissions for sponsors. In some embodiments multiple rules may exist for one rule type, for example, one rule may apply to sponsors that are also somewhere upline of the user who made the sale, while a different sponsor rule may apply if the sponsor is cross-line, meaning they are not anywhere upline of the user who made the sale.

The 106 Multiline MLM Commission Database contains commissions calculated by the 104 Multiline MLM Commission Module which are then used by the 107 Multiline MLM Additional Line Module to determine if the user qualifies for an additional line, in some embodiments this data may be used by another module to pay commissions to users, which comprises at least a user ID, for example, AB0001, a commission value, for example, $30, the type of commission, for example, downline, the user ID of the user the commission came from, for example, NM6677, and a date, for example, Sep. 18, 2020, if the commission came from a sale made somewhere in a user's downline then the commission will be considered to come from the immediately downline user, in other embodiments the commission may be recorded as coming from the selling user.

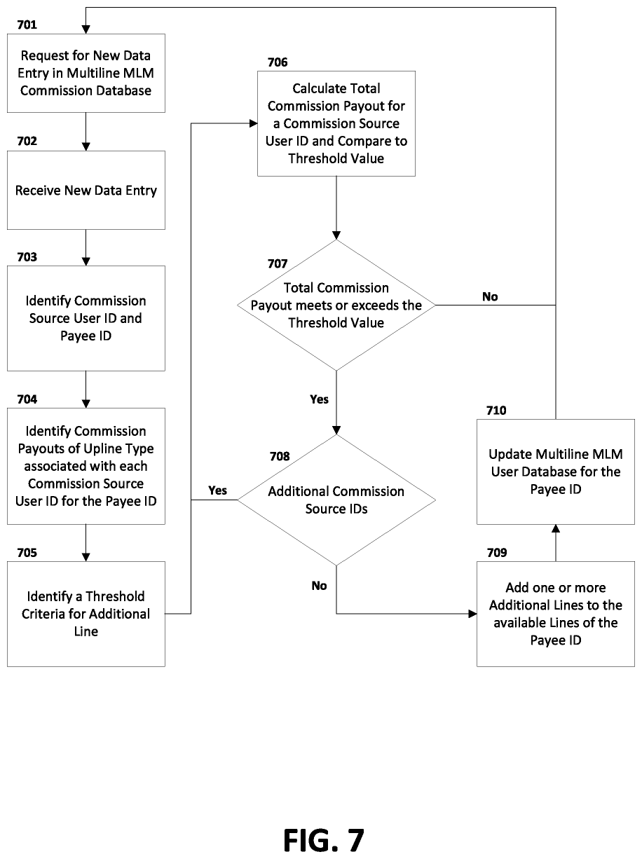

107 Multiline MLM Additional Line Module determines whether a user is eligible for an additional line, as further explained in FIG. 7.

108 Multiline MLM Merger Module may poll for data from the 111 Unilevel MLM Unilevel Base Module, 121 Matrix MLM Matrix Base Module, or 131 Binary MLM Binary Base Module. This data is extracted by the Base Module of each type of MLM from the respective database of user data. The 108 Multiline MLM Merger Module receives data from the 111 Unilevel MLM Unilevel Base Module, 121 Matrix MLM Matrix Base Module, or 131 Binary MLM Binary Base Module which includes a user ID, for example, AB0001, information on user's position in the 101 Multiline MLM commission structure via the user ID of the user above them in the commission structure, for example, FH1234, who enrolled or sponsored the user in the 101 Multiline MLM, for example, user ID TT9876, and how many lines the user currently has in the 110 Unilevel MLM, for example, 7. In some embodiments where the number of lines is restricted then he number of lines may not be included with each user but sent as one value. For example a 131 Binary MLM may be assumed to allow 2 lines for each user, and a 120 Matrix MLM may have a known maximum number of lines, for example 5, which is already accounted for by the system or sent to the 108 Multiline MLM Merger Module alongside the user data. The 108 Multiline MLM Merger Module sends the data to the 151 Admin Network AN Base Module to be stored in the 152 Admin Network AN User Database, in an embodiment user data without a number of lines will be set to the default value, for example data from a 130 Binary MLM may not contain data for the amount of lines because all members of a 130 Binary MLM have 2 available lines, in which case the data will be amended to include the default number of lines that would be assigned to a new member of the 140 Merged MLM. In an embodiment if the number of lines a user has is less than the default value it will be set to the default value, in an embodiment the default value is 4 lines. In an embodiment the 108 Multiline MLM Merger Module checks the data for errors and corruption before sending it to the 151 Admin Network AN Base Module.

111 Unilevel MLM Unilevel Base Module extracts the data stored in the 112 Unilevel MLM Unilevel User Database. The 111 Unilevel MLM Unilevel Base Module connects with the 108 Multiline MLM Merger Module through the 109 Cloud or Internet, via a physical connection, or by any other method of transferring data. The 111 Unilevel MLM Unilevel Base Module sends the data extracted from the 112 Unilevel MLM Unilevel User Database to the 108 Multiline MLM Merger Module.

The 112 Unilevel MLM Unilevel User Database contains information on user's position in the 110 Unilevel MLM commission structure, who enrolled or sponsored the user in the 110 Unilevel MLM, and how many lines the user currently has, which includes a user ID, for example, UL002, information on user's position in the 101 Multiline MLM commission structure, for example the user ID of the user above them in the commission structure, for example, UL001, who enrolled or sponsored the user in the 101 Multiline MLM, for example, user ID UL009, and how many lines the user currently has within the existing 110 Unilevel MLM.

121 Matrix MLM Matrix Base Module extracts all the data stored in the 122 Matrix MLM Matrix User Database. The 121 Matrix MLM Matrix Base Module connects with the 108 Multiline MLM Merger Module through the 109 Cloud or Internet, via a physical connection, or by any other method of transferring data. The 121 Matrix MLM Matrix Base Module sends the data extracted from the 122 Matrix MLM Matrix User Database to the 108 Multiline MLM Merger Module.

The 122 Matrix MLM Matrix User Database contains information on user's position in the 120 Matrix MLM commission structure, who enrolled or sponsored the user in the 120 Matrix MLM, and how many lines the user currently has, which includes a user ID, for example, AB0001, information on user's position in the 101 Multiline MLM commission structure.

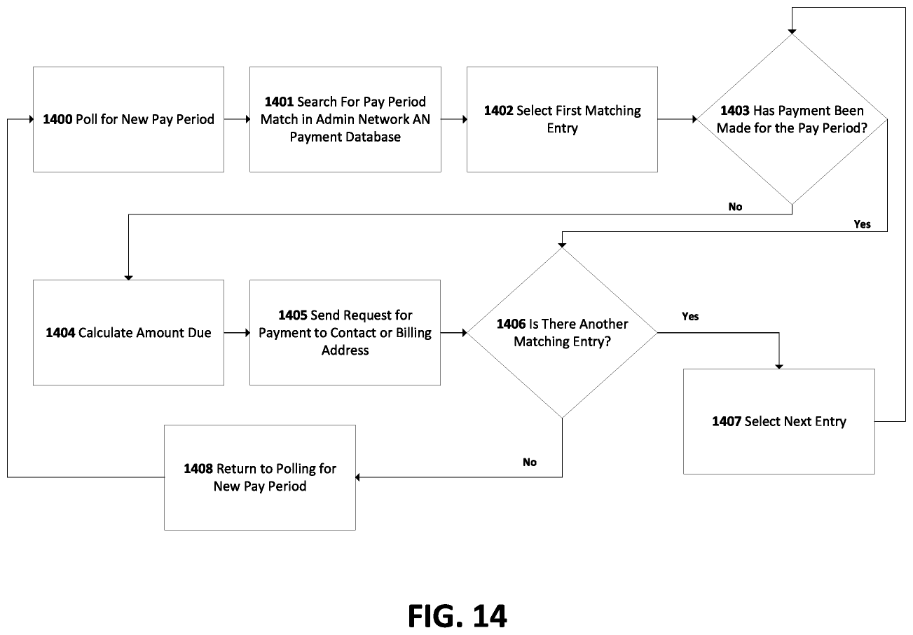

The 131 Binary MLM Binary Base Module extracts all the data stored in the 132 Binary MLM Binary User Database. The 131 Binary MLM Binary Base Module connects with the 108 Multiline MLM Merger Module through the 109 Cloud or Internet, via a physical connection, or by any other method of transferring data, at step 1302. The 131 Binary MLM Binary Base Module sends the data extracted from the 132 Binary MLM Binary User Database to the 108 Multiline MLM Merger Module. The 132 Binary MLM Binary User Database contains information on user's position in the 130 Binary MLM commission structure, who enrolled or sponsored the user in the 130 Binary MLM, and how many lines the user currently has, which includes a user ID, for example, BN002, information on user's position in the 101 Multiline MLM commission structure, for example the user ID of the user above them in the commission structure, for example, BN001, who enrolled or sponsored the user in the 101 Multiline MLM, for example, user ID BN001, and how many lines the user currently has within the existing 130 Binary MLM, for example, 7, FIG. 14B shows a possible commission structure based on the data in FIG. 14A, wherein the straight lines indicate an upline/downline relationship between two users and a curved, arrowed line indicates that the user the arrow points to was sponsored by the user the line originates from, and the dotted straight line indicates the two users have an indirect upline/downline relationship, meaning there are more users in the line that are not shown, more lines and users may exist than are shown, element 1400.

FIG. 2 illustrates a Unilevel MLM User Structure. In Unilevel MLM User structure, there are only upline and downline relationships between sponsors and those who are recruited by the sponsors. A user that is recruited to the organization by a sponsor becomes the downline of the sponsor. For example, Sponsor X 201 who recruited User/Sponsor B 203 may be connected to User/sponsor B 203 via an immediate downline connection 202. In the Unilevel MLM User Structure, any number of users recruited by Sponsor X 201 may be connected to Sponsor X 201 via an immediate downline connection 202. A User/Sponsor 203 may be connected to the Sponsor 201 via an immediate upline connection 204. The User/Sponsor B 203 may also recruit and connect to any number of users 207 via an immediate downline connection 205 and each of the any number of users 207 may be connected to the User/Sponsor 203 via an immediate upline connection 206. The Unilevel MLM User Structure may allow Sponsor X 201 to receive commission from each User/Sponsor 203 with an immediate upline connection to the Sponsor X 201. The Sponsor X 201 may also receive commission from any number of users 207 that have an immediate upline connection 206 to the User/Sponsor 203 that also has an immediate upline connection 204 with the Sponsor X 201. For example, User E may pay commission to User/Sponsor B 203 and Sponsor X 201. In some embodiments, the Sponsor X 201 may only receive commission from users with immediate upline connections to the Sponsor X 201. Depending on the position of the user in the organization hierarchy, the rate of commission may vary. For example, Users E, F, G, and H may receive one rate of commission whereas Users B, C, D may receive another rate of commission that is different. Additionally, the commission rate may vary based on the relationship between the users. For example, User/Sponsor B may receive a certain rate of commission from User E whereas Sponsor X may receive a different rate of commission from User E.

FIG. 3 illustrates a Binary MLM User Structure. In Binary MLM User structure, there are only two possible downline relationships between sponsors and those who are recruited by the sponsors. A user that is recruited to the organization by a sponsor becomes the downline of the sponsor if the sponsor does not yet have two users in the downline. For example, Sponsor X 301 who recruited User/Sponsor B 303 may be connected to User/sponsor B 303 via an immediate downline connection 302. In the Binary MLM User Structure, two users recruited by Sponsor X 301 may be connected to Sponsor X 301 via an immediate downline connection 302. A User/Sponsor 303 may be connected to the Sponsor 301 via an immediate upline connection 304. The User/Sponsor B 303 may also recruit and connect to two users 307 via an immediate downline connection 305 and each of the two users 307 may be connected to the User/Sponsor 303 via an immediate upline connection 306. The Binary MLM User Structure may allow Sponsor X 301 to receive commission from each User/Sponsor 303 with an immediate upline connection to the Sponsor X 301. The Sponsor X 301 may also receive commission from any number of users 307 that have an immediate upline connection 306 to the User/Sponsor 303 that also has an immediate upline connection 304 with the Sponsor X 301. For example, User E may pay commission to User/Sponsor B 303 and Sponsor X 301. In some embodiments, the Sponsor X 301 may only receive commission from users with immediate upline connections to the Sponsor X 301. Depending on the position of the user in the organization hierarchy, the rate of commission may vary. For example, Users E, F, G, and H may receive one rate of commission whereas Users B, C, D may receive another rate of commission that is different. Additionally, the commission rate may vary based on the relationship between the users. For example, User/Sponsor B may receive a certain rate of commission from User E whereas Sponsor X may receive a different rate of commission from User E.

A sponsor, such as Sponsor X 301, that is connected to two downline users may recruit crossline users 309 and connect with the crossline users via a crossline sponsors connection 308. The sponsor may receive a different commission rate for crossline users connected via a crossline sponsor connection 308 compared to the commission rate for users in the downline connection 302. Further, the sponsor may not receive commission from subsequent users 310 recruited by crossline users 309. For example, User/Sponsor B may receive 10% commission from User E and User F in the downline of User/Sponsor B. User/Sponsor B may also receive 5% commission from users recruited in the future by User E and User F that are placed in the downline of User E, User F, and User/Sponsor B. User/Sponsor B may receive a different commission rate from User I through a crossline connection 308, such as 12% crossline commission. However, User/Sponsor B will not receive commission from User K and User L 310 recruited by User I, as User I only has a crossline connection with User/Sponsor B.

FIG. 4 illustrates a Matrix MLM User Structure. In Matrix MLM User structure, there are only upline and downline relationships between sponsors and those who are recruited by the sponsors. A user that is recruited to the organization by a sponsor becomes the downline of the sponsor. The sponsor may recruit new users to fill any open position in a matrix structure until the matrix is filled with a user in each position. The matrix structure is defined by the number of immediate downlines or width, and the number of levels of downlines or depth. For example, Sponsor X 401 who recruited User/Sponsor B 403 may be connected to User/sponsor B 403 via an immediate downline connection 402. In the Matrix MLM User Structure, a fixed number of users may be recruited by Sponsor X 401 based on the number of available positions in the matrix. The matrix structure in FIG. 4 is an example of a 3×2 matrix. In this example, each sponsor may have three immediate downlines, and each of the immediate downlines may have three further downlines, for a total of twelve positions. The matrix structure may use any combination of two numbers to define the number of downlines and the number of levels to create a matrix structure. User/Sponsor B 403 may be connected to Sponsor X 401 via an immediate downline connection 402. A User/Sponsor B 403 may be connected to the Sponsor 401 via an immediate upline connection 404. The User/Sponsor B 403 may connect to a fixed number of users 407 via an immediate downline connection 405. The fixed number of users 407 may be recruited by either Sponsor X 401 or User/Sponsor B 403 and may connect to User/Sponsor B 403 and Sponsor X 401 via an upline connection 406. The Matrix MLM User Structure may allow Sponsor X 401 to receive commission from each user with an upline connection to the Sponsor X 401 until the matrix is occupied by a user in each position. The Sponsor X 401 may not receive commission from any number of users in a downline outside the matrix structure, such as users recruited by the fixed number of users 407. For example, User E may pay commission to User/Sponsor B 403 and Sponsor X 401, but any users recruited by User E may not pay commission to Sponsor X 401. Depending on the position of the user in the organization hierarchy, the rate of commission may vary. For example, Users E, F, G, and H may receive one rate of commission whereas Users B, C, D may receive another rate of commission that is different. Additionally, the commission rate may vary based on the relationship between the users. For example, User/Sponsor B may receive a certain rate of commission from User E whereas Sponsor X may receive a different rate of commission from User E.

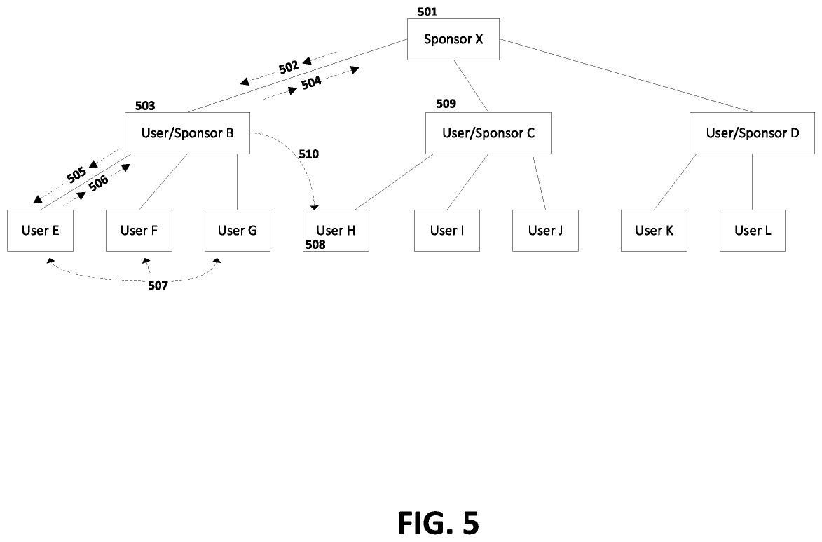

FIG. 5 Illustrates a Multiline MLM User Structure. A Multiline MLM User Structure may include at least a Sponsor and a User wherein the Sponsor is a salesperson that has recruited the User to the Multiline MLM organization. A Sponsor 501 may be connected to one or more users via an immediate downline connection 502, such as the immediate downline connection 502 between Sponsor 501 and User/Sponsor 503. A User/Sponsor 503 may be connected to the Sponsor 501 via an immediate upline connection 504. The User/Sponsor 503 may also recruit and connect to any number of users 507 via an immediate downline connection 505 and each of the any number of users 507 may be connected to the User/Sponsor 503 via an immediate upline connection 506.

The Multiline MLM User Structure, may limit the number of users connected to a sponsor (i.e. Sponsor 501 or User/Sponsor 503) via an immediate downline connection. This limitation may be configured as a rule in the Multiline MLM User Database 102. A maximum number of users connected to the sponsor via an immediate downline connection rule may be configured based on various factors including but not limited to the position of the user or sponsor in the Multiline MLM User Structure, the number of upline connections connected to the user or sponsor, the number of downline connections connected to the user or sponsor, the total commission earned by the user or sponsor, the total sales made by the user or sponsor, the commission earned from each of the downlines of the user or sponsor, or any combination therein. For example, the Multiline MLM User Structure in FIG. 5 may include a rule that allows for a maximum of 4 users connected to the User/Sponsor 503 via an immediate downline connection 505. The User/Sponsor 503 may recruit a new user 508. In the case that the User/Sponsor 503 is already connected to the maximum number of users allowed via an immediate downline, the new user 508 may be placed in an immediate downline of a different user 509. The User/Sponsor 503 may be connected to the new user 508 via a sponsor connection 510. The maximum number of users connected to a sponsor may be raised if the sponsor has met a threshold criteria. The threshold criteria may include the sales amount of the user that exceeds a threshold amount, commission received from each downline that exceeds a threshold amount, and total commission received from all the downline of the user exceeding a threshold amount. Further, the threshold criteria may be weighted based on the relationship between users. For example, a commission received as an upline may be weighted heavier than the commission received as a sponsor towards determining whether the user is eligible for an additional line. The threshold amount a user must meet may vary based on the number of downlines the user already has and the position of the user in the organization hierarchy.

The Multiline MLM User Structure may allow a sponsor to receive commission from each user with an immediate upline connection to the sponsor, such as the User/Sponsor 503 receiving commission from the any number of users 507. The sponsor may also receive commission from any number of users with an upline connection to the users that have an immediate upline connection to the sponsor. For example, Sponsor 501 may receive commission from the any number of users 507, as the any number of users 507 has an immediate upline connection 506 to the User/Sponsor 503 that has an immediate upline connection 504 to the Sponsor 501. Further, a sponsor may receive commission from users the sponsor has recruited if the user is not in their downline via a sponsor connection, such as the User/Sponsor 503 receiving commission via the sponsor connection 510 from the new user 508. Depending on the position of the user in the organization hierarchy, the rate of commission may vary. Additionally, the commission rate may vary based on the relationship between the users. A sponsor may receive one rate of commission from the user whereas an upline may receive a different rate of commission from the user. The rate of commission may also vary based on amount of sales exceeding a certain threshold value. For example, a sale under $500 may grant 5% in commission whereas a sale over $500 may grant 10% in commission.

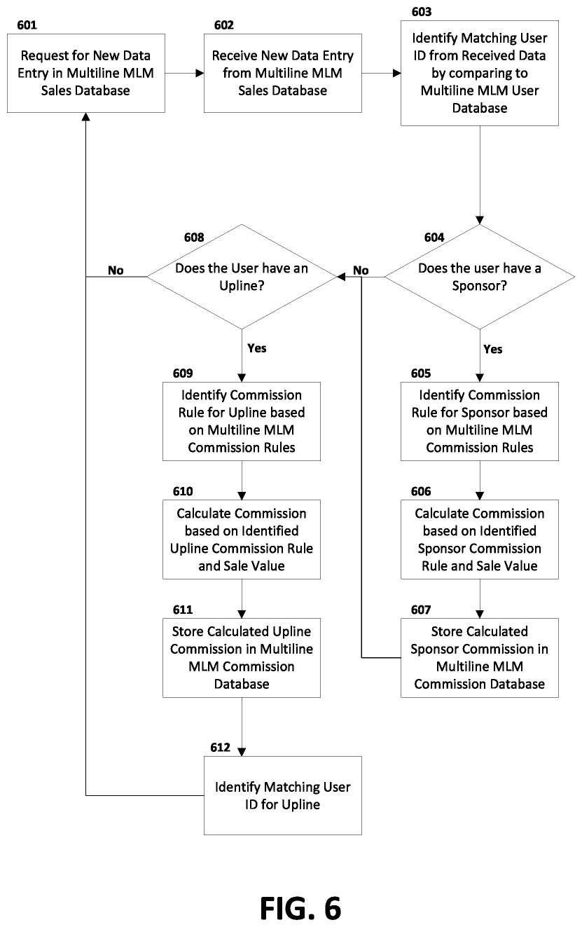

FIG. 6 illustrates a Multiline MLM Commission Module. The Multiline MLM Commission Module 104 may request a new data entry from the Multiline MLM Sales Database 103 at step 601. The new data entry may include any new sales data not yet processed by the Multline MLM Commission Module 104. New sales data may include information about a user and a sale associated with the user including a user ID, a sale value, a sale date, among other information. At step 602, The Multiline MLM Commission Module 104 may receive the new data entry and may compare it to the Multiline MLM User Database 102 to identify the user that made the sale in step 603. Identifying the user in the Multiline MLM User Database 102 may include identifying information associated with the position of the user in the Multiline MLM User Structure, other users in the upline or downline of the user, a sponsor of the user, and various other user information associated with the user. At step 604, the Multiline MLM Commission Module 104 may determine if the user has a sponsor. If the user does not have a sponsor, the Multiline MLM Commission Module 104 may skip to step 608. If the user has a sponsor, the Multiline MLM Commission Module 104 may identify a commission rule for the sponsor connection based on the Multiline MLM Commission Rules Database 105 at step 605. For example, the commission rule for the sponsor connection may include a percentage commission owed to the sponsor irrespective of the sponsor being in the upline of the user, such as 5% of the sale value.

At step 606, the Multiline MLM Commission Module 104 may calculate the commission owed to the sponsor based on the identified sponsor connection commission rule and the sale value of the user sale. For example, the user may have made a sale for $100, and the sponsor connection commission rule may state that the sponsor of the user should receive 5% of the sale value for a commission total of $5. In step 607, the Multiline MLM Commission Module 104 may store the calculated sponsor commission total in the Multiline MLM Commission Database 106. The stored commission total may be stored and associated with various users for different reasons. For example, the commission total may be stored associated with the sponsor user ID as commission paid by the specific user to the sponsor, added to the total commission earned for the sponsor, associated with the selling user ID as the commission paid by the specific user, or in any similar combination. At step 608, the Multiline MLM Commission Module 104 may identify if the user has an upline user that is owed commission who not the sponsor of the user. The commission to be paid by the user may be calculated differently for a sponsor, an upline and an upline who is also a sponsor. Similar to steps 605-607, the Multiline MLM Commission Module 104 identifies commission rules for the upline user of the selling user at step 609, calculates commission for the upline user based on one or more commission rules and the sale value at step 610, and stores the calculated commission in the Multiline MLM Commission Database 106 at step 611. At step 612, the Multiline MLM Commission Module 104 may identify if there is commission for additional upline users that has not yet been calculated. If the upline user ID does not match any upline user IDs that have already had commission calculated, the new upline user ID is processed by returning to step 608. If the upline user ID does match an upline user ID that has already had commission calculated and there is no additional upline user ID to process, the Multline MLM Commission Module restarts the process, at step 601.

FIG. 7 illustrates a Multiline MLM Additional Line Module. At step 701 Multiline MLM Additional Line Module 107 may request a new data entry from the Multiline MLM Commission Database 106. The new data entry may include commission data not yet processed by the Multiline MLM Additional Line Module 107. At step 702, the Multiline MLM Additional Line Module 107 receives the new commission data entry. Attributes of the commission data entry such as a commission source user ID, a payee ID, a commission type, a commission payout value, a payment date, among other information may be identified by the Multiline MLM Additional Line Module 107 at step 703. At step 704, the Multiline MLM Additional Line Module 107 identifies and separates commission payouts with the commission type “upline” from commission payouts with the commission type “sponsor.” In some embodiments, additional commission lines may be added to a user based only on commissions received from the downline of the user and may not be based on commission paid to the sponsor of the user.

At step 705, the Multiline MLM Additional Line Module 107 may identify a threshold criteria for addition an additional line that must be met or surpassed by each commission source user ID associated with the payee ID. Such criteria may include one or more threshold values a user must meet from sales and received commission. There may be a threshold value for total commission received from the downlines of the user, another threshold value for commission received from each of the downlines of the user, and yet another threshold for the total sales that the user has made. The threshold values may vary for each users based on the data regarding the user, such as the position of the user in the Multiline MLM structure, the number of downlines the user already has, and the relationship between the users. The threshold criteria may be weighted based on the relationship between the users. For example, the commission type “upline” may be considered more heavily than the commission type “sponsor” in determining whether the threshold criteria to create an additional line has been met.

In step 706, the Multiline MLM Additional Line Module 107 may calculate the total commission payout from a source user ID including previously paid commission and any new or unprocessed commission from the source user ID. Total commission payouts may be calculated based on a variety of rules, which may consider the total lifetime commission from the downline user, the commission from the downline user over a certain period of time, and the commission from a type of product. The Multiline MLM Additional Line Module 107 may compare the calculated total commission payout to the threshold value of commission payouts. Based on the calculation in step 706, the Multiline MLM Additional Line Module 107 may determine if the total commission paid to the payee ID is greater than, equal to, or less than the threshold value of commission payouts.

In step 707, if the total commission payout from the source user ID does not meet or exceed the threshold value, the payee ID user may not receive an additional line, and the process restarts at step 701. If the total commission payout from the source user ID does meet or exceed the threshold value, the Multiline MLM Additional Line Module 107 may identify an additional commission source ID that has not yet been processed at step 708. If the Multiline MLM Additional Line Module 107 identifies an additional commission source ID, the process returns to step 706, and repeats for the new commission source ID. If the Multiline MLM Additional Line Module 107 does not identify any additional commission source ID, one or more additional lines may be added to the available lines of the payee ID at step 709. The Multiline MLM Additional Line Module 107 may execute a variety of rules associated with adding one or more additional lines to the payee ID based on the position of the user in the Multiline MLM organization, total lines available to the user, total commission paid to the user, number of users that the user has sponsored, or any combination of rules. In some embodiments, the Multiline MLM Additional Line Module 107 may add multiple additional lines to the available lines for the user.

In step 710, the Multiline MLM Additional Line Module 107 may update the Multiline MLM User Database 102 for the payee ID with the one or more additional lines. In some embodiments, the one or more additional lines may include no users, or may include users with no sales data. If an additional line includes no users or no sales data, the Multiline MLM Additional Line Module 107 may enter a placeholder nominal value or null value in the Multiline MLM User Database 102 that may later be replaced by user and sales data. The Multiline MLM Additional Line Module 107 may repeat the process at step 701 upon conclusion of updating the Multiline MLM User Database 102.

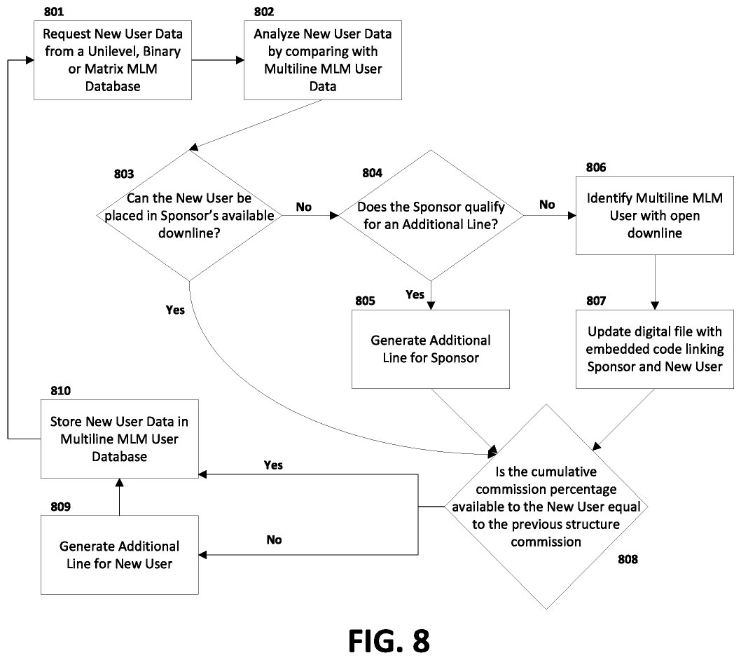

FIG. 8 illustrates a Multiline MLM Merger Module. At step 801, the Multiline MLM Merger Module 108 requests and receives new user data from a First MLM Database. The First MLM Database may include the 111 First Base Module, 112 First User Database, the 113 First Rules Database, or any combination of databases. The new user data may contain various user data records related to the user within the First MLM such as the user ID, sales value, commission earned, upline connections, downline connections, sponsor ID, commission rules associated with the user and user position in the First MLM, among other data. The relationships between users in the First MLM are embedded with a unique code and saved in a digital file in the Multiline User Database 104. Such code may be used to create and maintain the upline and downline relationship and to calculate commissions.

The unique code may be assigned or obtained by a new user via an online interaction (e.g., an online purchase) with a specific product webpage associated with the code. A link to the product webpage may be provided to the new user via a universal resource locator (URL) or an embedded URL in which the embedded unique code provides referral information associated with a upline user. When the new user engages in an online interaction with the product webpage, a new unique code is generated for the new user. The new unique code provides that the new user becomes related to the upline user as well as other distributors that previously purchased the product. Users that subsequently use the new link may each be given a respective different unique code that provides the respective set of upline users. After an online interaction meets certain conditions (e.g., a product purchased at the website), commissions may be paid out to the associated set of upline users specified by the unique code embedded in the link according to a defined commission levels.

At step 802, the Multiline MLM Merger Module 108 may analyze the new user data from the First MLM by comparing the new user data to the user data saved in the Multiline MLM User Database 102. Comparing user data between the First MLM and Multiline MLM may be executed using various different algorithms to match the First MLM user data to the sponsor, upline and downline users, and relative position within the First MLM organization.

At step 803, the Multiline MLM Merger Module 108 determines whether the new user can be placed downline of the sponsor of the user. If the sponsor has available space for a downline user, the Multiline MLM Merger Module may skip to step 808. If the sponsor of the user does not have available space for a downline user, the Multiline MLM Merger Module 108 may proceed to step 804. The Multiline MLM Merger Module 108 may then identify if the sponsor qualifies for an additional line by executing the process for the Multiline MLM Additional Line Module 107 described in FIG. 7. If the sponsor qualifies for an additional line, the Multiline MLM Additional Line Module 107 may generate an additional line for the sponsor at step 805. The Multiline MLM Merger Module 108 may store the new user data in the new additional line of the sponsor and may proceed to step 808. In this case, the existing relationships in the previous organization are maintained.

If the sponsor does not qualify for an additional line, the Multiline MLM Merger Module 108 may identify another user in the Multiline MLM with an open downline user available at step 806. The identified user may be selected at random or selected based on position in the organization, the number of available downlines, and the number of total downlines the user has. The Multiline MLM Merger Module 108 may store the data associated with the new user who is in the downline of the identified user.

At step 807, the Multiline MLM Merger Module 108 may update the digital file associated with the new user data and the sponsor user data. The upline and downline relationship between the new user and the sponsor is severed and the new user and the sponsor are linked in a crossline relationship. The digital file is embedded with a new unique code and the Multiline MLM User Database is updated accordingly with the new unique code.

At step 808, the Multiline MLM Merger Module 108 may compare commission data associated with the new user received from the First MLM to the commission data and rules for the position of the new user in the Multiline MLM. Various mathematical procedures may be executed to calculate an equivalent commission rate that the user could receive from the downline. In some embodiments, if the commission rate for the new user in the Multiline MLM is less than the commission rate for the same user in the First MLM, the Multiline MLM Merger Module 108 may generate an additional downline for the new user at step 809. In other words, if the user is expected to receive less commission in the Multiline MLM than what the user used to receive in the First MLM, the user may be entitled to additional downlines until the user could receive comparable commission in the Multiline MLM. In another embodiment, the Multiline MLM Merger Module 108 may send a request for a change in commission rules to the Multiline MLM Commission Rules Database 105, and may update the commission rules of the new user in the Multiline MLM to equal the commission rate for the user in the First MLM. Various requests may be made to a combination of databases available in the Multiline MLM in order to adjust the available commission rate to be equal or comparable to the previous commission rate in the First MLM.

At step 810, the Multiline MLM Merger Module 108 may store the new user data in the Multiline MLM User Database 102 and any other database of the Multiline MLM that contains updated information for the user. The Multiline MLM Merger Module 108 may proceed back to step 801 and may repeat the process until all available users in the First MLM have been created in the Multiline MLM User Database 102. Further, the Multiline MLM Merger Module 108 may repeat step 801 through step 810 for a Second MLM, or any number of additional MLM organizations.

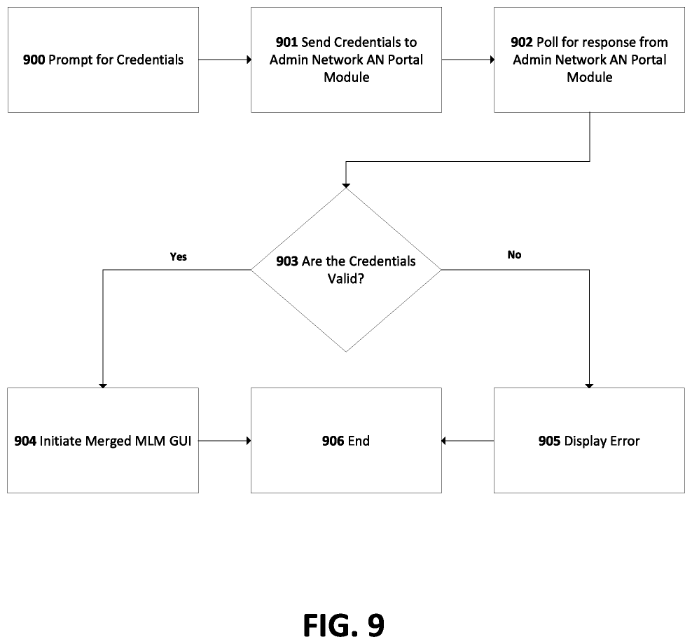

FIG. 9 illustrates the 141 Merged MLM Merged Base Module. The process begins with the 141 Merged MLM Merged Base Module prompting for credentials to be entered by an agent or executive of the 140 Merged MLM. In some embodiments a member of the 140 Merged MLM may be prompted for credentials. In some embodiments credentials may be entered automatically by the 141 Merged MLM Merged Base Module or another module. Credentials include at least a password, but may also include a username, company ID, IP address, email address, additional passwords or verification methods, MAC address, or other credentials. In some embodiments this prompting may occur using the 143 Merged MLM GUI or another GUI, at step 900. The 141 Merged MLM Merged Base Module sends the credentials to the 158 Admin Network AN Portal Module to be verified, at step 901. The 141 Merged MLM Merged Base Module polls for a response from the 158 Admin Network AN Portal Module, indicating the validity of the credentials, at step 902. The 141 Merged MLM Merged Base Module determines if the credentials are valid based on the response from the 158 Admin Network AN Portal Module. The response is a simple Boolean TRUE or FALSE statement where TRUE means, for example, the credentials are valid, at step 903. If the credentials are valid, the 141 Merged MLM Merged Base Module initiates the 143 Merged MLM GUI which will, through the 142 Merged MLM API, allow the 140 Merged MLM or its agents or members access to data and modules on the 150 Admin Network, requests to change, pull, or send data are made via the 143 Merged MLM GUI and may be send over the 109 Cloud or Internet, or via some other communications method which may involve a module to handle communications, at step 904. If the credentials are not valid, the 141 Merged MLM Merged Base Module displays an error message or creates a log of the error. The error may contain a description, for example, “Login Failed.” In some embodiments, the 158 Admin Network AN Portal Module may send back more detailed information about the failure and different error messages may be displayed or logged based on the type of failure, for example, “No such username”, “Password Incorrect”, “Account is no up to date”, or “Unauthorized IP Address”, at step 905. The 141 Merged MLM Merged Base Module ends, in another embodiment the 141 Merged MLM Merged Base Module does not end until the session has been disconnected by the 140 Merged MLM or the 150 Admin Network, at step 906.

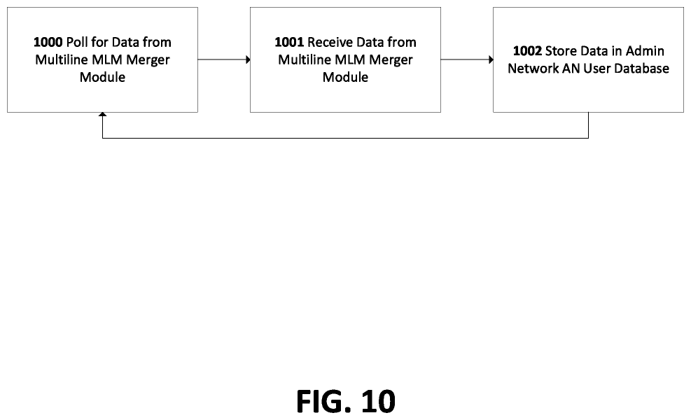

FIG. 10 illustrates the functioning of the 151 Admin Network AN Base Module. The process begins with the 151 Admin Network AN Base Module polling for data from the 108 Multiline MLM Merger Module, which includes user data on users from the MLMs being merged, at step 1000. The 151 Admin Network AN Base Module receives data from the 108 Multiline MLM Merger Module, at step 1001. The 151 Admin Network AN Base Module stores the received data in the 152 Admin Network AN User Database, at step 1002.

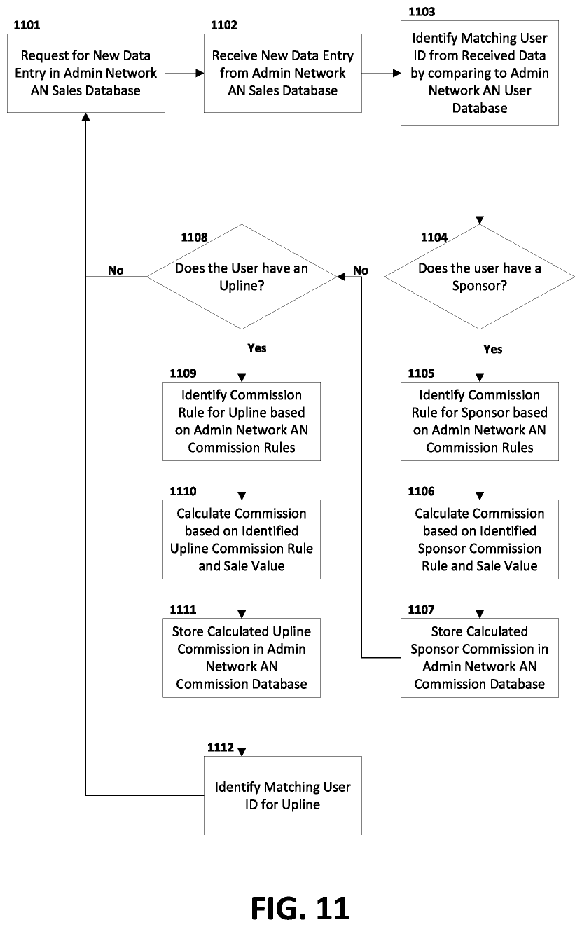

FIG. 11 illustrates the functioning of the Admin Network AN Commission Module. The process begins with the 154 Admin Network AN Commission Module polling for a new data entry in the 153 Admin Network AN Sales Database, for example, when a sale is made by a user, at step 1101. The 154 Admin Network AN Commission Module extracts the new data entry from the 153 Admin Network AN Sales Database which includes at least a user ID, sales value, and date, at step 1102. The 154 Admin Network AN Commission Module searches for a User ID in the 152 Admin Network AN User Database that matches the user ID extracted from the 153 Admin Network AN Sales Database, for example if the extracted user ID had a value of “UL001” then the 154 Admin Network AN Commission Module will search the 152 Admin Network AN User Database for a value of “UL001” in the “User ID” category, at step 1103. The 154 Admin Network AN Commission Module selects the entry in the 152 Admin Network AN User Database with a matching user ID value. The 154 Admin Network AN Commission Module determines if the user has a sponsor by checking the entry for a value in the “Sponsor User ID” category, if there is no value, or the value does not correspond to a user ID then the 154 Admin Network AN Commission Module will skip to step 1916, at step 1104. If there is a value that corresponds to a user ID in the “Sponsor User ID” category, the 154 Admin Network AN Commission Module extracts the commission rule from the 155 Admin Network AN Commission Rule Database for sponsor users, at step 1105. The 154 Admin Network AN Commission Module applies the extracted commission rule to the sales value extracted from the 153 Admin Network AN Sales Database. For example, if the rule is 10% commission for sponsors and the sales value is $300, then $300 will be multiplied by 10% to get $30 which is the commission payable to the sponsor. In an embodiment, the sponsor may be paid directly by the 154 Admin Network AN Commission Module after this step, at step 1106. At step 1107, the 154 Admin Network AN Commission Module stores the resulting commission in the 156 Admin Network AN Commission Database along with the user ID of the sponsoring user to be paid, the user ID of the sponsored user, the commission type, in this case sponsor, and the date extracted from the 153 Admin Network AN Sales Database. In some embodiments, the date may be changed to reflect a delay in the processing of the commission or payment of the commission. The 154 Admin Network AN Commission Module determines if the user has an upline user by checking the entry for a value in the “Upline User ID” category, if there is no value, or the value does not correspond to a user ID then the 154 Admin Network AN Commission Module will return to polling for a new data entry in the 153 Admin Network AN Sales Database, at step 1108. If there is a value that corresponds to a user ID in the “Upline User ID” category, the 154 Admin Network AN Commission Module extracts the commission rule from the 155 Admin Network AN Commission Rule Database for upline users, at step 1109. The 154 Admin Network AN Commission Module applies the extracted commission rule to the sales value extracted from the 153 Admin Network AN Sales Database. For example if the rule is 10% commission for upline users and the sales value is $300, then $300 will be multiplied by 10% to get $30 which is the commission payable to the upline user. In some embodiments users may receive a different commission based on how many levels upline they are from the user who made the sale. For example, the upline user of the upline user may earn 5% commission, and next upline user may earn 1% commission. In an embodiment the upline user may be paid directly by the 154 Admin Network AN Commission Module after this step, at step 1110. At step 1111, the 154 Admin Network AN Commission Module stores the resulting commission in the 156 Admin Network AN Commission Database along with the user ID of the upline user to be paid, the user ID of the downline user, the commission type, in this case upline, and the date extracted from the 153 Admin Network AN Sales Database. In some embodiments the date may be changed to reflect a delay in the processing of the commission or payment of the commission. The 154 Admin Network AN Commission Module then searches the 152 Admin Network AN User Database for an entry where the user ID in the “User ID” category matches the user ID in the “Upline User ID” category of the currently selected entry. at step 1112. The 154 Admin Network AN Commission Module selects the entry with the matching user ID value as the new selected entry and returns to step 1104.

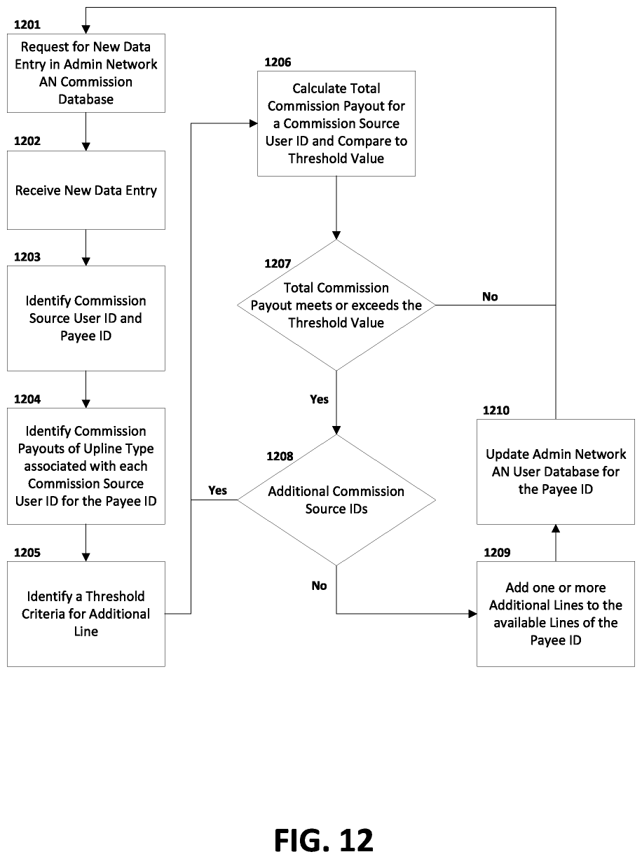

FIG. 12 illustrates the functioning of the 157 Admin Network AN Additional Line Module. At step 1201 Admin Network AN Additional Line Module 157 may request a new data entry from the Admin Network AN Commission Database 156. The new data entry may include commission data not yet processed by the Admin Network AN Additional Line Module 157. At step 1202, the Admin Network AN Additional Line Module 157 receives the new commission data entry. Attributes of the commission data entry such as a commission source user ID, a payee ID, a commission type, a commission payout value, a payment date, among other information may be identified by the Admin Network AN Additional Line Module 157 at step 1203. At step 1204, the Admin Network AN Additional Line Module 157 identifies and separates commission payouts with the commission type “upline” from commission payouts with the commission type “sponsor.” In some embodiments, additional commission lines may be added to a user based only on commissions received from the downline of the user and may not be based on commission paid to the sponsor of the user.

At step 1205, the Admin Network AN Additional Line Module 157 may identify a threshold criteria for addition an additional line that must be met or surpassed by each commission source user ID associated with the payee ID. Such criteria may include one or more threshold values a user must meet from sales and received commission. There may be a threshold value for total commission received from the downlines of the user, another threshold value for commission received from each of the downlines of the user, and yet another threshold for the total sales that the user has made. The threshold values may vary for each users based on the data regarding the user, such as the position of the user in the Admin Network AN structure, the number of downlines the user already has, and the relationship between the users. The threshold criteria may be weighted based on the relationship between the users. For example, the commission type “upline” may be considered more heavily than the commission type “sponsor” in determining whether the threshold criteria to create an additional line has been met.

In step 1206, the Admin Network AN Additional Line Module 157 may calculate the total commission payout from a source user ID including previously paid commission and any new or unprocessed commission from the source user ID. Total commission payouts may be calculated based on a variety of rules, which may consider the total lifetime commission from the downline user, the commission from the downline user over a certain period of time, and the commission from a type of product. The Admin Network AN Additional Line Module 157 may compare the calculated total commission payout to the threshold value of commission payouts. Based on the calculation in step 1206, the Admin Network AN Additional Line Module 157 may determine if the total commission paid to the payee ID is greater than, equal to, or less than the threshold value of commission payouts.

In step 1207, if the total commission payout from the source user ID does not meet or exceed the threshold value, the payee ID user may not receive an additional line, and the process restarts at step 1201. If the total commission payout from the source user ID does meet or exceed the threshold value, the Admin Network AN Additional Line Module 157 may identify an additional commission source ID that has not yet been processed at step 1208. If the Admin Network AN Additional Line Module 157 identifies an additional commission source ID, the process returns to step 1206, and repeats for the new commission source ID. If the Admin Network AN Additional Line Module 157 does not identify any additional commission source ID, one or more additional lines may be added to the available lines of the payee ID at step 1209. The Admin Network AN Additional Line Module 157 may execute a variety of rules associated with adding one or more additional lines to the payee ID based on the position of the user in the Admin Network AN organization, total lines available to the user, total commission paid to the user, number of users that the user has sponsored, or any combination of rules. In some embodiments, the Admin Network AN Additional Line Module 157 may add multiple additional lines to the available lines for the user.

In step 1210, the Admin Network AN Additional Line Module 157 may update the Admin Network AN User Database 152 for the payee ID with the one or more additional lines. In some embodiments, the one or more additional lines may include no users, or may include users with no sales data. If an additional line includes no users or no sales data, the Admin Network AN Additional Line Module 157 may enter a placeholder nominal value or null value in the Admin Network AN User Database 152 that may later be replaced by user and sales data. The Admin Network AN Additional Line Module 157 may repeat the process at step 1201 upon conclusion of updating the Admin Network AN User Database 152.

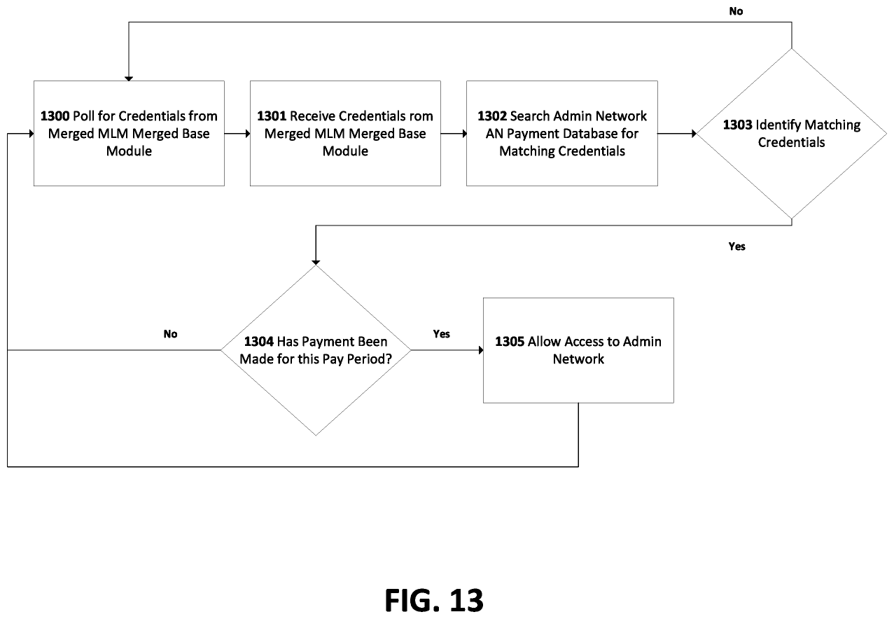

FIG. 13 illustrates the functioning of the 158 Admin Network AN Portal Module. The process begins with the 158 Admin Network AN Portal Module polling for credentials from the 141 Merged MLM Merged Base Module. Credentials include at least an MLM ID or other identifier such as a username and a password, at step 1300. The 158 Admin Network AN Portal Module receives the credentials from the 141 Merged MLM Merged Base Module, at step 1301. The 158 Admin Network AN Portal Module searches the 160 Admin Network AN Payment Database for matching credentials, which any entries that match both the MLM ID and password, at step 1302. The 158 Admin Network AN Portal Module determines if there are any matches, if not then the credentials are invalid and the 158 Admin Network AN Portal Module sends an error message to the 141 Merged MLM Merged Base Module. In an embodiment this message may contain a string, for example, “Invalid Login Information.”, at step 1303. If there is at least one matching entry, the 158 Admin Network AN Portal Module searches the matching entries for the one that corresponds to the current pay period. For example if it is currently March of 2020, then the entry for the pay period March 2020 will be selected, then the 158 Admin Network AN Portal Module determines if the value in the “Paid Balance” category of the entry is equal to or higher than the value in the “Service Fee” category, if the value in the “Paid Balance” category of the entry is lower than the value in the “Service Fee” category then the account has an outstanding debt and the 158 Admin Network AN Portal Module sends an error message to the 141 Merged MLM Merged Base Module, in an embodiment this message may contain a string, for example, “Account Not Current. Please Contact Billing Department.”, at step 1304. If the value in the “Paid Balance” category of the entry is equal to or higher than the value in the “Service Fee” category, The 158 Admin Network AN Portal Module allows the 140 Merged MLM, its agents, executives, members, or combination thereof, access to some or all of the modules and databases in the 150 Admin Network, and sends a notification to the 141 Merged MLM Merged Base Module that credentials were valid and the account was paid to date, in an embodiment this notification may include a string, for example, “Login Successful.” at step 1305.

FIG. 14 illustrates the functioning of the 159 Admin Network AN Payment Module. The process begins with the 159 Admin Network AN Payment Module polling for a new pay period based on the current system date and time. In an embodiment date and time may be retrieved from an online source via the 109 Cloud or internet, the pay period is not necessarily the actual date and time, for example the pay period for March, 2020 may begin on Jan. 15, 2020 so that the 140 Merged MLM or other payer has sufficient time to make a payment, at step 1400. The 159 Admin Network AN Payment Module searches the 160 Admin Network AN Payment Database for entries that match the current pay period, at step 1401. The 159 Admin Network AN Payment Module selects the first matching entry from the 160 Admin Network AN Payment Database, at step 1402. The 159 Admin Network AN Payment Module determines if payment has been made for the current pay period by determining if the value in the “Paid Balance” category of the entry is equal to or higher than the value in the “Service Fee” category. If payment has been made then the 159 Admin Network AN Payment Module will skip to step 1406, at step 1403. If payment has not been made for the current pay period, the 159 Admin Network AN Payment Module calculates the amount due by subtracting the value in the “Paid Balance” category of the entry from the value in the “Service Fee” category. For example if $5000 is the service fee and $3000 has already been paid, then the amount due is $2000, at step 1404. The 159 Admin Network AN Payment Module sends a request or bill for the amount due to the contact or billing address stored in the selected entry, the amount due may be accompanied by other informational text, for example, “Your [PAY PERIOD] payment is due by [DATE]. Your Current Amount Due is: [AMOUNT DUE]. Please make check payable to [COMPANY] or visit [WEBSITE].” at step 1405. The 159 Admin Network AN Payment Module determines if there is another matching entry in the 160 Admin Network AN Payment Database, at step 1406. If there is another matching entry, the 159 Admin Network AN Payment Module selects the next entry and returns to step 1403, at step 1407. *If there are no more matching entries, the 159 Admin Network AN Payment Module returns to polling for a new pay period, at step 1408.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claim.

1. (canceled)

2. A method for merging different user structures into a multiline user structure, the method comprising:
storing information in a database regarding at least a first user structure with a first set of lines corresponding to existing relationships, and a second user structure with a second set of lines corresponding to existing relationships;
receiving data for at least one member of the first user structure or the second user structure, the data regarding at least a position of the at least one member within the respective user structure and corresponding to a set of relationships of the at least one member;
merging the first user structure and the second user structure to create a new merged multiline user structure that includes the at least one member, wherein the set of relationships of the at least one member is integrated into and maintained within the merged multiline user structure; and
transmitting data regarding the merged multiline user structure to an administrative network computer computer over a communication network, wherein the administrative network computer updates the merged multiline user structure to add one or more additional lines corresponding to new relationships with the at least one member based on the data.

3. The method of claim 2, further comprising adding the additional lines to the merged multiline user structure based on threshold criteria by the administrative network computer.

4. The method of claim 3, further comprising identifying that the threshold criteria are met based on weighting one or more of the relationships between the at least one member and one or more members that are downline from the at least one member within the merged multiline user structure.

5. The method of claim 3, further comprising determining a total distribution received by the at least one member, wherein the threshold criteria include the total distribution.

6. The method of claim 5, wherein the administrative network computer determines the total distribution of the at least one member based on stored rules in a database of the administrative network computer.

7. The method of claim 6, wherein the administrative network computer distributes the total distribution to the at least one member via the communication network.

8. The method of claim 3, further comprising identifying one or more distributions received by the at least one member from each set of relationships of the at least one member, wherein the threshold criteria include the one or more distributions.

9. The method of claim 3, further comprising identifying total online interactions associated with the at least one member, wherein the threshold criteria include the total online interactions.

10. The method of claim 9, wherein identifying the total online interactions includes receiving online data associated with a code of the at least one member from a third-party vendor system

11. The method of claim 2, further comprising entering a placeholder value by the administrative network computer to add the additional lines to the merged multiline user structure.

12. The method of claim 11, further comprising replacing the placeholder value with user data based on online usage of a unique code associated with the at least one member.

13. The method of claim 12, wherein the unique code is an embedded uniform resource location (URL) of a webpage.

14. The method of claim 13, wherein the online usage of the unique code is at the webpage, and further comprising generating a new unique code based on the online usage of the unique code at the webpage by a device of a new member.

15. The method of claim 2, wherein the transmitted data regarding the merged multiline user structure to the administrative network computer is stored in a database of the administrative network computer.

16. The method of claim 15, further comprising providing a network portal, wherein the network portal provides access to the database of the administrative network computer upon verifying credentials of the at least one member.

17. A system for merging at least two multi-level user structures into a multiline user structure, the system comprising:
a first database that stores information regarding a first user structure with a first set of lines corresponding to existing relationships;
a second database that stores information regarding a second user structure with a second set of lines corresponding to existing relationships;
a merger module in communication with the first database and the second database, wherein the merger module is executable by a processor to merge the first user structure and the second user structure to create a new merged multiline user structure that includes at least one member, wherein the set of relationships of the at least one member is integrated into and maintained within the merged multiline user structure; and
an administrative network computer in communication with the merger module that:
receives and stores data regarding the merged multiline user structures in memory; and
updates the merged multiline user structure to add one or more additional lines corresponding to new relationships with the at least one member.

18. The system of claim 17, wherein the administrative network computer adds the additional lines to the merged multiline user structure based on a threshold criteria.

19. The system of claim 17, further comprising a network portal provided by the administrative network computer, wherein the network portal provides access to the database of the administrative network computer upon verifying credentials of the at least one member.

20. A non-transitory, computer-readable storage medium, having embodied thereon a program executable by a processor to perform a method for merging at least two user structures into a multiline user structure, the method comprising:
storing information in a database regarding at least a first user structure with a first set of lines corresponding to existing relationships, and a second user structure with a second set of lines corresponding to existing relationships;
receiving data for at least one member of the first user structure or the second user structure, the data regarding at least a position of the at least one member within the respective user structure and corresponding to a set of relationships of the at least one member;
merging the first user structure and the second user structure to create a new merged multiline user structure that includes the at least one member, wherein the set of relationships of the at least one member is integrated into and maintained within the merged multiline user structure; and
transmitting data regarding the merged multiline user structure to an administrative network computer over a communication network, wherein the administrative network computer updates the merged multiline user structure to add one or more additional lines corresponding to new relationships with the at least one member based on the data.
